(19) United States
(12) Patent Application Publication
(10) Pub. No.: US 2007/0065095 A1
(43) Pub. Date: Mar. 22, 2007

(54) Video display device, and method for controlling reproduction of recording on recording medium of the device

(75) Inventor: Takashi Kitamura, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA.

(21) Appl. No.: 11/475,880

(22) Filed: Jun. 28, 2006

(30) Foreign Application Priority Data
Jun. 29, 2005 (JP) 2005-190096

(51) Int. Cl. H04N 5/91

(52) U.S. Cl. 386/46

(57) ABSTRACT

A video display device comprises a signal processing unit which outputs a processed signal, a static first recording medium, a dynamic second recording medium which is driven by a drive unit, a first control unit which starts recording the processed signal onto the first recording medium when a prescribed instruction signal is issued, a second control unit which activates the drive unit of the second recording medium when the prescribed instruction signal is issued, and a third control unit which reads out the signal recorded on the first recording medium to record it onto the second recording medium when an operation-of the drive unit becomes stable.

### CROSS-REFERENCE TO RELATED APPLICATIONS

This application is based upon and claims the benefit of priority from Japanese Patent Application No. 2005-190096, filed Jun. 29, 2005, the entire contents of which are incorporated herein by reference.

### BACKGROUND

1. Field

One embodiment of the invention relates to a video display device and a method for controlling a reproduction of recording on a recording medium of the device. And, for instance, the display device and the method are effective for a device and a method which is equipped with a power saving function for energy saving measures.

2. Description of the Related Art

In recent years, an information recording medium such as a hard disk and an optical disk as a recording medium has been increased in its recording capacity. Therefore, a method and a device which connects or incorporates a recording reproduction device using such a recording medium to a television receiver, etc., to automatically record a desired program on the recording medium have been used. Of course, a dedicated recording reproduction device with a tuner and a hard disk device (HDD) built therein to record a program, etc., has been developed. When the dedicated recording reproduction device is used, the display unit of the television receiver is employed as a monitor.

On the other hand, in recent years, energy saving measures has been demanded by the public. In response to this demand, in a device equipped with the HDD, a device designed to improve power saving and a user convenience has been developed (for instance, Jpn. Pat. Appln. KOKAI Publication No. 09-234763). This device is configured to monitor a used condition and an unused condition of the device with the HDD (for example, personal computer and monitor) and to enable altering a period until a disk motor stops automatically depending on the use and nonuse conditions of the device. When in the use condition, this device makes the period until the disk motor stops automatically longer and when in the nonuse condition, this device makes the period shorter.

A technique described in Jpn. Pat. Appln. KOKAI Publication No. 2004-087052 is presented for a device to reduce power consumption. This device transfers data from an HDD to a buffer memory at a high speed, and reads to reproduce the data at a lower speed in comparison with a speed to read it from the buffer memory. Accordingly, the HDD in the device generates a margin timewise and this margin brings the HDD into a sleep state to reduce the power consumption.

A device to reduce the power consumption is disclosed by the technique described in Jpn. Pat. Appln. KOKAI Publication No. 2004-252570. This device has a disk array and sets a minimum hard disk in a standby state in a power saving state.

As mentioned above, the devices equipped with the HDDs, respectively, are designed to save power and most of them are devised in manners to stop the HDDs. However, since the devices stop their HDDs, the devices have to pay attention to failures caused by restarting the HDDs. That is, it takes several dozen seconds before the HDDs are respectively brought into normal operating states sometimes. Therefore, even if operations to start recording information are effected, the devices cannot record the information on the hard disks immediately, and the devices possibly fail to record important information or scenes.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary external appearance view explaining a television broadcast receiving device in an embodiment of the present invention;

FIG. 2 is an exemplary block diagram explaining a signal processing system of the television broadcast receiving device in the embodiment of the present invention;

FIG. 3 is an exemplary schematic view of a remote controller used in a video display device of the present invention;

FIG. 4 is an exemplary flowchart explaining operations of essential units of the present invention;

FIG. 5 is an exemplary view extracting configuration blocks of the essential units of the present invention; and

FIG. 6 is an exemplary block diagram explaining another example of the signal processing system of the television broadcast receiving device regarding the present invention.

### DETAILED DESCRIPTION

Various embodiments according to the invention will be described hereinafter with reference to the accompanying drawings. In general, according to one embodiment of the invention, one embodiment of the present invention provides a video display device and a method for controlling a recording medium which stably stores (records) information at the same time when an instruction to start recording the information is reached and surely records the information on a hard disk since the instruction has been issued.

According to the embodiment, the video display device comprises a signal processing unit which outputs a processed signal; a static first recording medium; a dynamic second recording medium which is dynamically driven by a drive unit; a first control unit which starts recording the processed signal onto the first recording medium when a prescribed instruction signal is issued; a second control unit which activates the drive unit of the second recording medium when the prescribed instruction signal is issued; and a third control unit which reads out the signal recorded on the first recording medium to record the signal onto the second recording medium when an operation of the drive unit becomes stable.

According to the aforementioned video display device, after the drive unit drives the second recording medium and until the operation becomes stable, the processed signal is recorded on the first recording medium. Then, after the operation of the second recording medium becomes stable, the display device records the processed signal through the first recording medium.

This embodiment will be explained with reference to the drawings in detail. At first, an outline of a broadcast receiving device with the present invention applied thereto will be described.

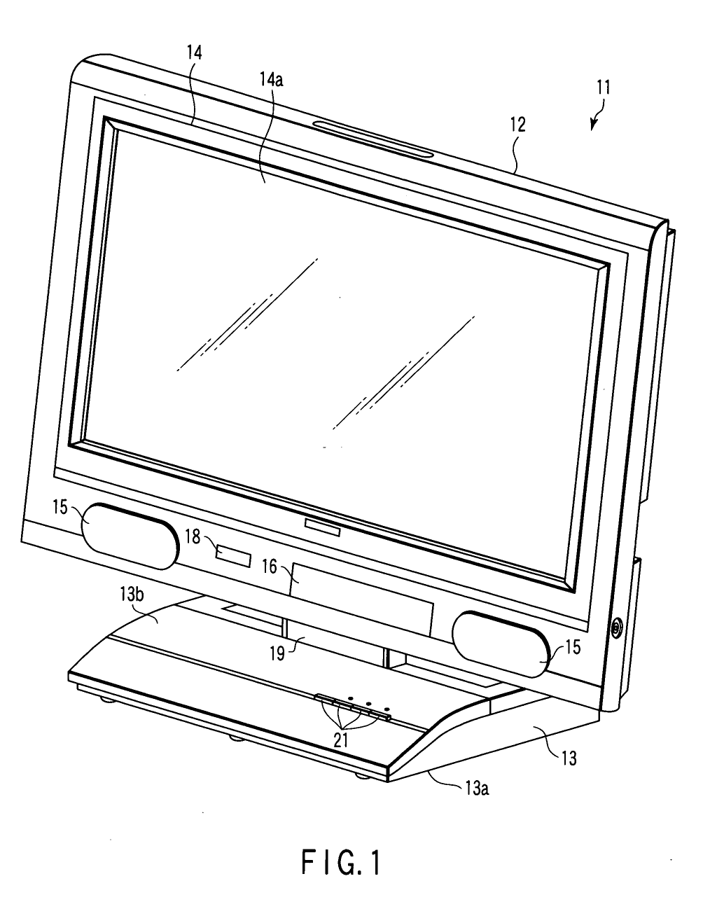

FIG. 1 shows an external appearance of a front face side of a television broadcast receiving device 11 described in the embodiment. In other words, the receiving device 11 is composed mainly of a low-profile cabinet 12 formed in an almost square shape to be a device main body and a stand 13 to elect and support the cabinet 12.

A display screen 14a of a video display unit 14 made of, for instance, flat-type liquid crystal display panel is exposed on a front surface of the cabinet 12. And also a pair of loudspeakers 15, an operating unit 16 a light receiving unit 18 to receive operation information transmitted from a below-mentioned remote controller (not shown in FIG. 1) are arranged on the front surface of the cabinet 12.

The stand 13 is formed in a roughly low-profile box shape and structured to mount a bottom surface plate 13a that is one flat surface of the stand 13 on a prescribed base (not shown) horizontally disposed. A support member 19 projected upward from an approximately central part of an upper surface plate 13b that is a surface on a side opposite to a surface mounted on the base is connected with a back surface of the cabinet 12. Then the support member 19 supports the cabinet 12 in an erected state thereof.

Here, the stand 13 enables housing a below-mentioned HDD unit 20 (not shown in FIG. 1) inside thereof. A plurality (four in FIG. 1) of operating buttons 21 possible to be depressed so as to control the HDD unit 20 into states of recording, reproducing, stopping and the like are arranged, at sections projected toward further front side than the cabinet 12, on the upper surface plate 13b of the stand 13.

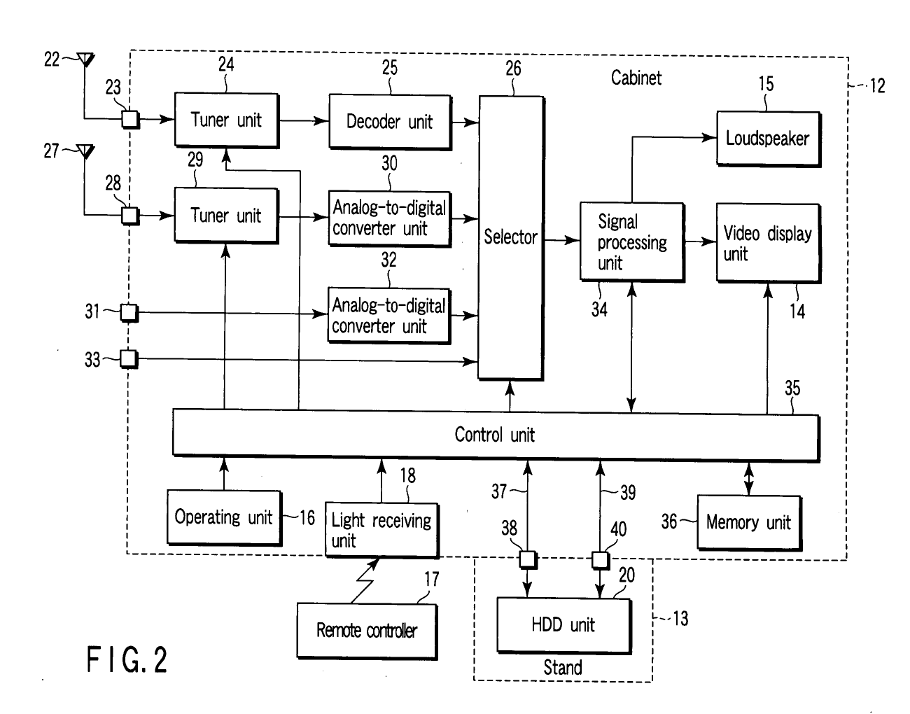

FIG. 2 schematically shows the signal processing system of the receiving device 11. A variety of circuit blocks constituting the signal processing system are disposed mainly at positions closer to the back surface inside the cabinet 12, namely, around the rear side of the display screen 14a of the video display unit 14.

A digital television broadcast signal received at an antenna 22 for receiving a digital television broadcast is supplied to a tuner unit 24 via an input terminal 23. The tuner unit 24 tunes a signal in a desired channel from the input digital television broadcast signal to demodulate it. The signal output from the tuner unit 24 is supplied to a decoder unit 25 and after, for example, moving picture experts group (MPEG) 2 decoding is performed thereto, the processed signal is supplied to a selector 26.

Furthermore, the receiving device 11 supplies an analog television broadcast signal received at an antenna 27 for receiving an analog television broadcast to a tuner unit 29 via an input terminal 28. The tuner unit 29 tunes a signal in a desired channel from the input analog television broadcast signal to demodulate it. The signal output from the tuner unit 29 is digitized by an analog/digital (A/D) converter 30 then output to the selector 26.

An A/D converter 32 digitizes the analog video and sound signals supplied from an input terminal 31 for an analog signal then outputs it to the selector 26. The digital video and sound signals supplied to an input terminal 33 for a digital signal is supplied to the selector 26 as they are.

The selector 26 selects one kind from four kinds of input digital video and sound signals to supply it to a signal processing unit 34. The processing unit 34 performs a prescribed signal process to the input digital video signal to display it as a video display on the video display unit 14. As for the display unit 14, a flat panel display made of, for instance, a liquid display and a plasma display, etc., is adopted. The processing unit 34 performs a prescribed signal process and an analog-conversion to the input digital sound signal to output the resultant signal to the loudspeaker 15, then, performs a sound reproduction.

Here, the receiving device 11 integrally controls a variety of operations including the above-described various receiving operations by means of a control unit 35. The control unit 35 is a micro processor with a central processing unit (CPU) and the like incorporated therein and respectively controls each unit so as to reflect its operation contents by receiving operation information from the operating unit 16 or operation information transmitted from the remote controller 17 via the light receiving unit 18.

In this case, the control unit 35 uses a static semiconductor memory unit 36. The memory unit 36 includes mainly a read only memory (ROM) with a control program executed by the CPU stored thereon, a random access memory (RAM) to provide an operational area for the CPU and a nonvolatile memory with a variety items of set information and control information stored thereon. The memory unit 36 may include a semiconductor memory of any type of an SRAM, a DRAM, etc.

The control unit 35 is connected with the HDD unit 20 including a hard disk that is a dynamic recording medium installed in the stand 13. In this case, a line 37 for supplying electric source power from the control unit 35 to the HDD unit 20 connects the control unit 35 with the HDD unit 20 through a connection terminal 38. Although a line of control data is laid down, it is omitted herein.

A line 39 for transmitting and receiving the digital video signal and the sound signal to and from the HDD unit 20 connects the control unit 35 to the HDD unit 20 through an i.Link connection terminal 40. That is, the i.Link transmits the digital video signal and the sound signal between the control unit 35 and the HDD unit 20 separately from the electric source and the control signal.

The receiving device 11 then can record the digital video signal and the sound signal selected by the selector 26 onto the HDD unit 20 and can also reproduce them recorded on the HDD unit 20 to be viewed.

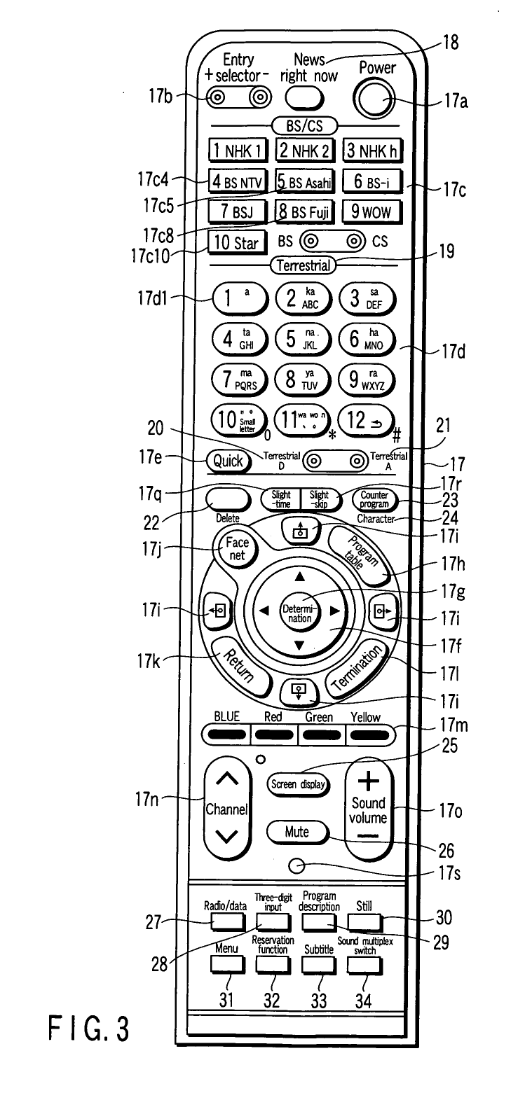

FIG. 3 shows the external appearance of the remote controller 17. The remote controller 17 mainly comprises a power supply key 17a, entry selector keys 17b, direct tuning keys for satellite broadcast channels 17c, direct tuning keys of terrestrial broadcast channels 17d, a quick key 17e, a cursor key 17f, a determination key 17g, a program table key 17h, page switching keys 17i, a face net (registered trade mark) (navigation) key 17j, a return key 17k, a termination key 17l, color keys in blue, red, green, yellow 17m, a channel up down key 17n, a sound volume adjusting key 17o, etc.

The remote controller 17 also has a slight-time key 17q and a slight-skip key 17r. The method to use the keys 17q and 17r will be described later. The receiving device 11 includes a function to save energy and enables setting an energy saving mode on a menu screen or the like by operating an energy saving key 17s for bringing the receiving device 11 into the energy saving mode.

Here, the receiving device 11 including the HDD unit 20 enables setting it to the energy saving mode. In the energy saving mode, the absence of an access to the HDD unit 20 for a fixed time period (for instance, 15 minutes) shifts the HDD unit 20 to a sleep mode to save energy. The HDD unit 20 is in a constant idling state usually (when energy saving mode is not set). The receiving device 11 may be configured to enable a user to arbitrarily change the time period of the 15 minutes and to change the time period of the 15 minutes when the receiving device 11 is designed.

The receiving device 11 further has a slight-time function. The slight-time function will be described here.

When the slight-time function is operated, the receiving device 11 utilizes the HDD unit 20 or the like as the recording medium to secure a prescribed use capacity or a capacity for a fixed recording time (for instance, six hours). The pressing of the time key 17q of the remote controller 17 by the user to leave the receiving receiver 11 in the middle during viewing the receiving device 11 causes the start of the operation of the slight-time function. At this moment, a moving image being on the air is maintained on the screen and a set menu is also displayed together with a comment of ‘slight time’. Then, the user can set an ‘energy saving mode’.

Subsequently, the screen becomes a state in which the moving image being on the air is maintained and also the screen displays a comment of ‘in preparation of slight time’. Next, the screen displays a comment of ‘start slight-time recording’. When observing the comment of the ‘start slight-time recording’, a viewer can observe the fact of the start of the slight-time recording.

After the elapse of the fixed time, when the viewer comes back to the setting place of the receiving device 11 to press the time key 17q, the receiving device 11 still continues recording. A reproduction start position is returned to a position at which temporary storage recording has started. That is, the receiving device 11 shifts to prepare a chase reproduction.

The receiving device 11 then shifts to a chase reproduction state of the video which has been recorded through the ‘slight-time recording’. The chase reproduction means the function of recording a video being on the air in real time and also of reproducing a content which has already recorded.

When intending the chase reproduction, the viewer may also operate the slight-time skip key 17r. In this manner, the viewer can skip the reproduction position. The viewer can skip, for example, a commercial message video or a scene of a video in which the viewer is not interested by operating the skip key 17r. When chasing the screen being on the air now by operating the skip key 17r, the viewer completes a temporary storage recording process (loop recording process).

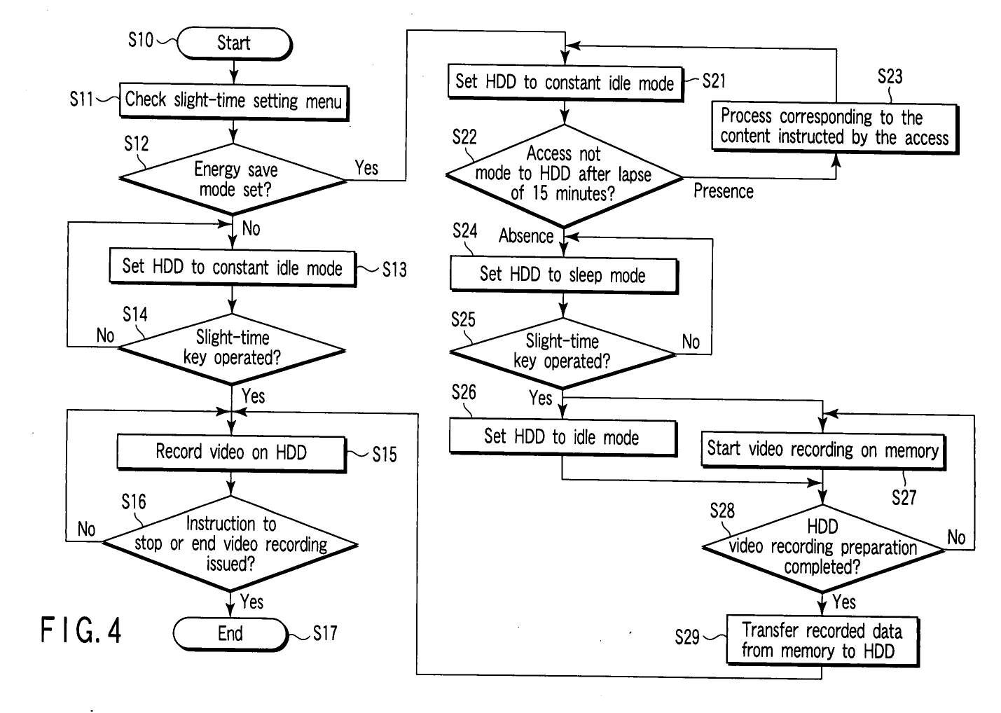

FIG. 4 is a flowchart showing the fact that the setting of the energy saving mode and the slight-time recording function are related to each other.

The receiving device 11 checks the setting menu to check whether it has been set to the energy saving mode or not (steps S11 and S12). If the energy saving mode has not been set, the HDD unit 20 is set to the constant idling mode as a default (step S13). If the slight-time key 17q is pressed (step S14), the HDD unit 20 becomes possible to perform a recording operation (step S15). When an instruction to stop or end recording is issued to the control unit 35, it stops the recording at the HDD unit 20 (step S16).

If the energy saving mode has been set, the receiving device 11 checks whether the HDD unit 20 is accessed or not for, for instance, 15 minutes (steps S21 and S22). If the HDD unit 20 is accessed, a process corresponding to the content instructed by the access is executed (step S23).

Otherwise stated, the HDD unit 20 shifts to the sleep mode from the idling state (steps S22 and S24).

In such a state, if the slight-time key 17q is operated, the HDD unit 20 is set to the idling mode from the sleep mode (step S26). Simultaneously, the receiving device 11 starts to record the processed signal output from a signal processing unit (for instance, signal processing unit 34 in FIG. 1) onto a memory (for instance, memory unit 36 in FIG. 1). After the HDD init 20 is switched to the idling mode, it takes a certain while until the HDD unit 20 becomes possible to stably record the processed signal. Then, it is determined whether or not the operation of the HDD unit 20 has become stable and the recording preparation has been completed (step S28). When the recording preparation is completed, the memory starts data transfer to the HDD unit 20 (step S29). Then, the data transferred from the memory is recorded on the HDD unit 20 (step S15).

As described above, after the HDD unit 20 is switched from the sleep mode to the idling mode, the HDD unit 20 continues the recording operation of the data from the memory. In other words, recording data is recorded on the hard disk though the memory.

The data output from the signal processing unit 34 to be recorded is, for example, compressed data (for instance, compressed data by MPEG system). Therefore, in the case of the compressed data, if data supply to the memory is switched to the HDD unit 20 even if the HDD unit 20 has been ready, the recorded data produces discontinuity. To avoid such a failure, then, the receiving device 11 maintains a route to record the data onto the hard disk.

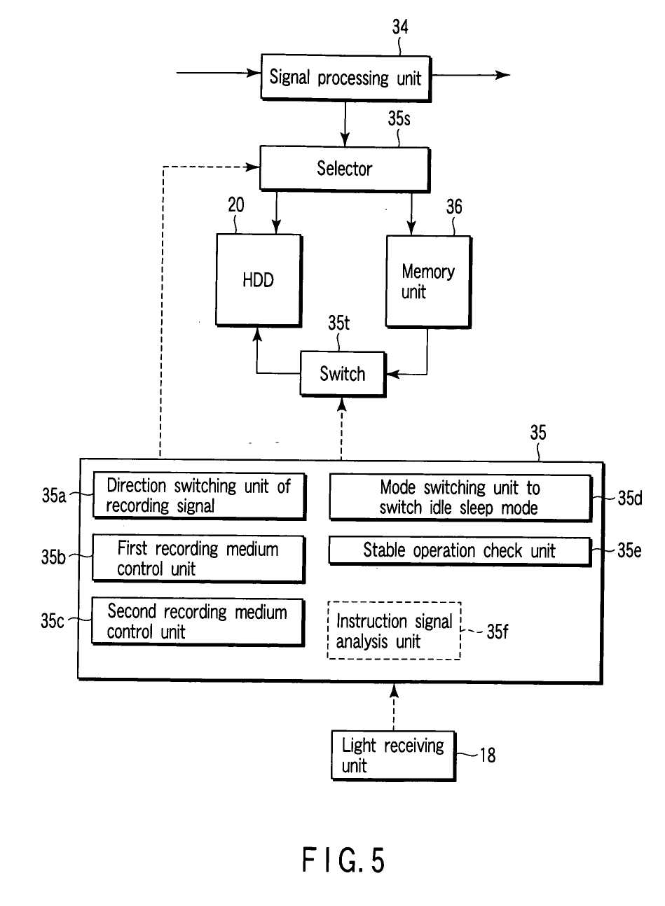

The process given above is executed by the control unit 35 in FIG. 1. An example of its configuration will be shown in FIG. 5.

In FIG. 5, the receiving device 11 can input the compressed data from the signal processing unit 34 outputting the processed signal to either the HDD unit 20 or the memory unit 36 through a selector 35s. The data read out from the memory unit 36 can be input to the HDD unit 20 through a switch 35t. The control unit 35 controls the selector 35s and the switch 35t. The control unit 35 includes a direction switching unit 35a of a recording signal to control flow of the data. If a first recording medium (wherein it means a memory unit 36 that is a static recording medium) is made symmetrical relative to access, the receiving device 11 includes a first recording medium control unit 35b to set an active state of the memory unit 36 for recoding or reading the recording signal thereon or therefrom and to execute recording or reading the recording signal. Similarly, if a second recording medium (wherein it means the HDD unit 20 that is an dynamic recording medium) is made symmetrical relative to the access, the receiving device 11 includes a second recording medium control unit 35c to set an active state of the HDD unit 20 for recoding or reading the recording signal thereon or therefrom and to execute recording or reading the recording signal.

The control unit 35 further includes a mode switching unit 35d to switch the idling mode and the sleeping mode of the HDD unit 20. The control unit 35 also includes a stable operation check unit 35e in the case of the shift of the HDD 20 from the sleep mode to the idling mode. The control unit 35 further includes an instruction signal analysis unit 35f to analyze an instruction signal extracted from the light receiving unit 18 in response to the operation of the user. The operations of each block have already explained in the flowchart in FIG. 4.

Accordingly, the first recording medium control unit 35b forms a first control unit to start recording the processed signal onto the memory unit 36 when the instruction signal for temporary storage is issued. The second recording medium control unit 35c configures a second control unit to start up the drive unit of the second recording medium when the instruction signal for the temporary storage is issued.

The check unit 35e and switching unit 35d forms a third control unit to reads out the signal recorded on the memory unit 36 and record the signal onto the hard disk of the HDD unit 20 when the operation of the HDD unit 20 becomes stable.

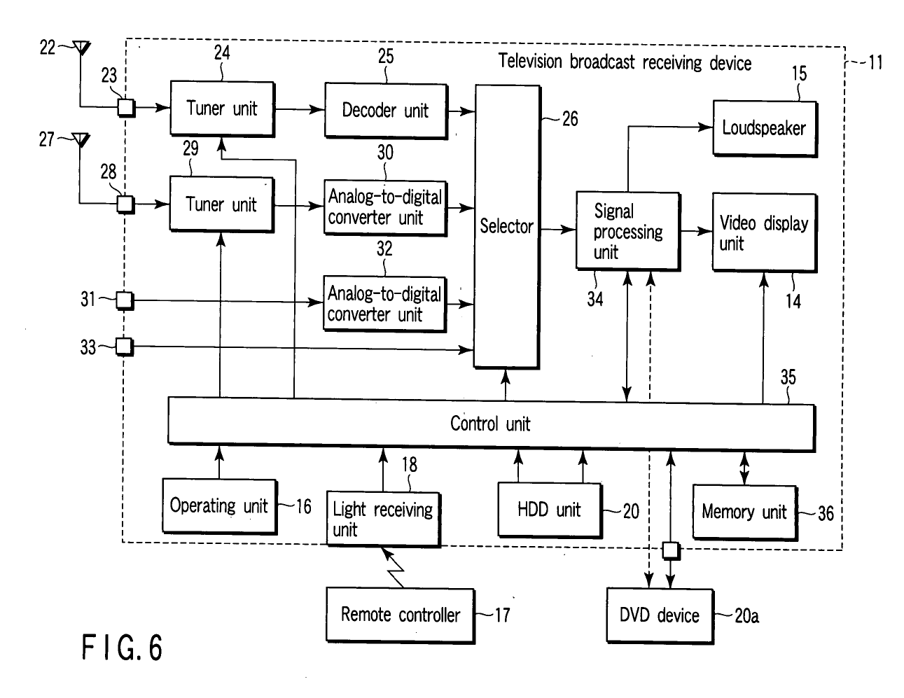

In FIG. 2, having described the signal processing system of the receiving device 11 by dividing it into the cabinet 12 and the stand 13, it is not necessary for the signal processing system to be described by specifically dividing into the cabinet 12 and the stand 13. And, as shown in FIG. 6, the signal processing system may be described equivalently as if the receiving device 11 contained the HDD unit 20 therein.

Having described about the energy saving measures for the HDD unit 20 in the explanation given above; however the measures are not limited for the HDD unit 20, a digital versatile disk (DVD) device 20a may be an object of the energy saving measures.

The invention is not limited to the specific details and representative embodiments shown and described herein, and in an implementation phase, various types of modifications may be made without departing from the spirit or scope of the general inventive concept of the invention. Various types of the invention can be formed by appropriately combining a plurality of constituent elements disclosed in the foregoing embodiments. Some of the elements, for example, may be omitted from the whole of the constituent elements shown in the embodiments mentioned above. The constituent elements over different embodiments further may be appropriately combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display device, comprising:
a signal processing unit which outputs a demodulated and processed signal;
a static first recording medium;
a dynamic second recording medium which is driven by a drive unit;
a first control unit which starts recording the processed signal onto the first recording medium when an instruction signal for temporary storage of the processed signal is issued;
a second control unit which activates the drive unit of the second recording medium when the instruction signal for the temporary storage is issued; and
a third control unit which reads out the signal recorded on the first recording medium to record the signal onto the second recording medium when an operation of the drive unit becomes stable.

2. The video display device according to claim 1, wherein the first recording medium is a semiconductor memory and the second recording medium is a hard disk.

3. The video display device according to claim 1, further comprising a sleep mode setting unit which sets the drive unit of the second recording medium to a sleep mode when an energy saving mode is set and any access is not performed to the drive unit of the second recording medium for a prescribed time period.

4. The video display device according to claim 1, wherein the first control unit maintains recording the processed signal onto the first recording medium even after the signal recorded on the first recording medium is recorded onto the second recording medium.

5. A video display device, comprising:
a signal processing unit which outputs a demodulated and processed signal;
a static first recording medium;
a dynamic second recording medium which is driven by a drive unit;
a sleep-mode setting unit which sets the drive unit of the second recording medium to a sleep mode when an energy saving mode is set and any access is not performed to the drive unit of the second recording medium for a prescribed time period;
a first control unit which starts recording the processed signal onto the first recording medium when an instruction signal for temporary storage of the processed signal is issued;
a second control unit which activates the drive unit of the second recording medium being in the sleep mode when the instruction signal for the temporary storage is issued; and
a third control unit which reads out the signal recorded on the first recording medium to record the signal onto the second recording medium when an operation of the drive unit becomes stable.

6. The video display device according to claim 5, wherein the first recording medium is a semiconductor memory and the second recording medium is a hard disk.

7. The video display device according to claim 5, wherein the first control unit maintains recording the processed signal onto the first recording medium even after the signal recorded on the first recording medium is recorded onto the second recording medium.

8. A method for controlling a reproduction of recording of a recording medium, which has a signal processing unit to output a demodulated and processed signal, a static first recording medium, a dynamic second recording medium to be driven by a drive unit and a control unit to integrate operations and which controls recording and reproducing the processed signal onto and from the first and the second recording media by the control unit, the method comprising:
setting the drive unit of the second recording medium to a sleep mode when an energy saving mode is set and any access is not performed to the drive unit of the second recording medium for a prescribed time period;
starting recording the processed signal onto the first recording medium when an instruction signal for temporary storage of the processed signal; and
reading out the signal recorded on the first recording medium to record the signal onto the second recording medium.

9. The method for controlling the reproduction of the recording of the recording medium according to claim 8, maintaining the recording of the processed signal onto the first recording medium even after the signal recorded on the first recording medium is recorded onto the second recording medium.

10. The method for controlling the reproduction of the recording of the recording medium according to claim 8, wherein the operation to record the signal read-out from the first recording medium to record it onto the second recording medium is continued until an instruction signal to stop or end video recording is issued to the control unit.
